(19) United States
(12) Patent Application Publication
(10) Pub. No.: US 2003/0184249 A1
(43) Pub. Date: Oct. 2, 2003

(54) Limited current sliding mode control for low RPM spindle motor speed regulation

(75) Inventors: Jeffrey A. Heydt, Oklahoma City, OK (US); Alfredo Gay Sam, Oklahoma City, OK (US); James W. DuLaney, Oklahoma City, OK (US); Ryan T. Lyle, Oklahoma City, OK (US)

Correspondence Address: Crowe & Dunlevy, 1800 Mid-America Tower, 20 North Broadway, Oklahoma City, OK, 73102-8273, US

(73) Assignee: Seagate Technology LLC, Scotts Valley, CA

(21) Appl. No.: 10/186,966

(22) Filed: Jun. 28, 2002

Related U.S. Application Data
(60) Provisional application No. 60/368,315, filed on Mar. 28, 2002.

(51) Int. Cl. G05B 11/01

(52) U.S. Cl. 318/560

(57) ABSTRACT

Method and apparatus for controlling a motor below a threshold velocity. During a velocity control mode, the motor is accelerated to an operational velocity, receives a commanded velocity value, and switches from a first control method to a second control method below the threshold velocity. The threshold velocity is determined from limitations of control electronics that do not function well when a motor current drops below the threshold level. The sliding mode control method measures the measured motor velocity, compares the velocity to the commanded velocity, applies a current value when the measured value is less than the commanded value and applies a negligible current value when the measured value is greater than the commanded value. The threshold level is dictated by the first control method. Back electromotive force (bemf) detection circuitry is used to measure the motor current.

### RELATED APPLICATIONS

This application claims priority to U.S. Provisional Application No. 60/368,315 filed Mar. 28, 2002.

### FIELD OF THE INVENTION

The claimed invention relates generally to the field of disc drive data storage devices and more particularly, but not by way of limitation, to a method and apparatus for low speed operation of a disc drive spindle motor.

### BACKGROUND

A disc drive is a data storage device used to store digital data. A typical disc drive includes a number of rotatable magnetic recording discs that are axially aligned and mounted to a spindle motor for rotation at a high constant velocity. A corresponding array of read/write heads access tracks defined on the respective disc surfaces to write data to and read data from the discs.

Disc drive spindle motors are typically provided with a three-phase, direct current (dc) brushless motor configuration. The phase windings are arranged about a stationary stator on a number of radially distributed poles. A rotatable spindle motor hub is provided with a number of circumferentially extending permanent magnets in close proximity to the poles. Application of current to the windings induces electromagnetic fields that interact with the magnetic fields of the magnets to apply torque to the spindle motor hub and induce rotation of the discs.

The position of the heads is controlled by electronic circuitry to allow the heads to access data on concentric tracks of the discs. The heads include an aerodynamic air bearing surface. Rotation of the discs causes air to be dragged beneath the air bearing surface such that a lifting force is created. This force in turn causes the heads to fly just above the disc surface and allow the reading and writing of data.

In many situations it is desirable to lower the fly height of the heads. During testing and development it is often useful to test the air bearing surface for different configurations of heads and varying rotational velocities of discs. Also, heads are sometimes intentionally lowered into contact with the disc surfaces to test a variety of effects on the resulting head-disc crash. Heads are also lowered in some burnishing applications to reduce asperities on the disc.

The fly height at which the head flies above the surface depends on several factors. A primary factor that determines the fly height of the head above the disc surface is the rotational velocity of the disc. Reducing the rotational velocity of the disc can result in a lowering of the head toward the disc surface.

Control electronics for a spindle motor generally provide for acceleration from rest up to an operational velocity. Although speed regulation routines are built into the control electronics, the routines are not as effective for lower end velocities. Most speed regulation is designed for governing the velocity at the higher end of the velocity spectrum and does not possess the capability for reducing the velocity to such ranges that cause the heads to crash onto the disc.

The servo code that controls the motor velocity generally controls the rotational velocity from the lower end threshold velocity up to an operational velocity. The threshold is influenced by the minimum current required to keep the power electronics functioning. A pulse width modulated input of a spindle driver typically gives a zero output for the low end of the duty cycle. As an example, a duty cycle in the range from 0 to 5% can be designed to result in a zero output. Above this range the output varies to full scale, but a minimum level current results.

The minimum commanded current results in a minimum obtainable speed. Due to the constraints of the power electronics, the minimum obtainable speed, or speed and current threshold (SCT), is greater than that desired for low speed operation. At the SCT lower speeds are not achievable since the current is at its lowest possible value and commanded speeds below the SCT still result in the minimum obtainable speed.

Accordingly, there is a need for improvements in the art whereby a high performance spindle motor can be reliably decelerated from an operational velocity to below a threshold velocity. It is to such improvements that the present invention is directed.

### SUMMARY OF THE INVENTION

In accordance with preferred embodiments, a disc drive includes a spindle motor, back electromotive force (bemf) detection circuitry which detects bemf from rotation of the spindle motor, motor control circuitry that applies a control current from a threshold velocity to an operational velocity, and sliding mode control circuitry that applies a control below a threshold velocity.

The motor control circuitry responds to commanded velocity values between the threshold velocity and the operational velocity, but applies current corresponding to the threshold velocity for commanded velocities below the threshold velocity. To operate the motor below the threshold velocity the sliding mode control is used.

Once a commanded velocity below the threshold velocity is received, a switch to sliding mode control occurs either at that point, or after the control circuitry has reduced the actual velocity below the threshold velocity. Sliding mode control then regulates the velocity from the threshold velocity and below.

Sliding mode control circuitry measures the motor velocity, preferably using the bemf detection circuitry, compares the measured velocity to the commanded velocity, and applies an appropriate value of current based oil a motor velocity error. If the motor is rotating at a velocity greater than the commanded value, a negligible current value is applied. If the motor is rotating a velocity less than the commanded value, a current value corresponding to a velocity between the threshold velocity or above is applied.

These and various other features and advantages which characterize preferred embodiments of the present invention will be apparent from a reading of the following detailed description and a review of the associated drawings.

### BRIEF DESCRIPTION OF THE DRAWINGS

FIG. 1 is a top plan view of a disc drive constructed in accordance with preferred embodiments of the present invention.

FIG. 2 provides a functional block diagram of the disc drive of FIG. 1.

FIG. 3 provides a functional block diagram of relevant portions of the motor control circuitry of FIG. 2.

FIG. 4 provides a schematic representation of rotor position sense (RPS) circuitry of the motor control circuitry of FIG. 3.

FIG. 5 is a flow chart for a VELOCITY CONTROL routine illustrative of steps carried out in accordance with preferred embodiments of the present invention to accelerate the spindle motor from rest to an operational velocity, then determine the type a control needed for velocities above and below a threshold velocity.

FIG. 6 is a flow chart for a SLIDING MODE CONTROL subroutine illustrative of steps carried out in accordance with preferred embodiments of the present invention to control the velocity of the motor below a threshold velocity.

FIG. 7 is a functional block diagram representative of programming used to implement the present invention.

### DETAILED DESCRIPTION

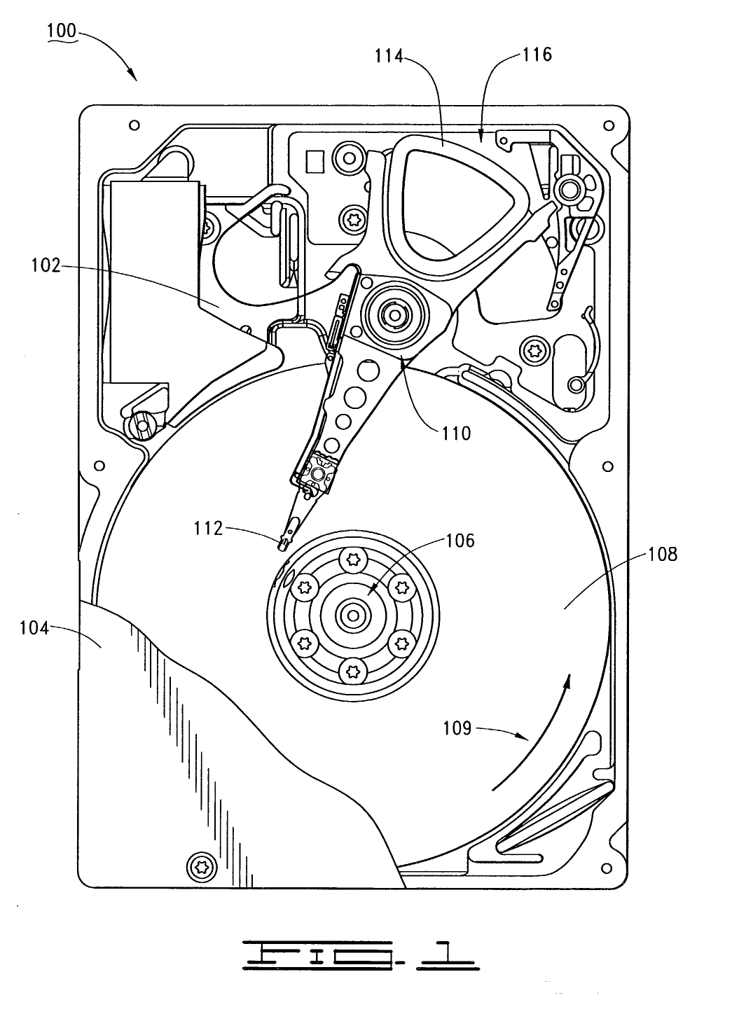

FIG. 1 provides a top plan view of a disc drive 100 constructed in accordance with preferred embodiments of the present invention. A base deck 102 and a top cover 104 (shown in partial cutaway) cooperate to form a sealed housing for the disc drive 100. A spindle motor 106 rotates a number of magnetic recording discs 108 in a rotational direction 109. An actuator assembly 110 supports an array of read/write heads 112 adjacent the respective disc surfaces. The actuator assembly 110 is rotated through the application of current to an actuator coil 114 of a voice coil motor (VCM) 116.

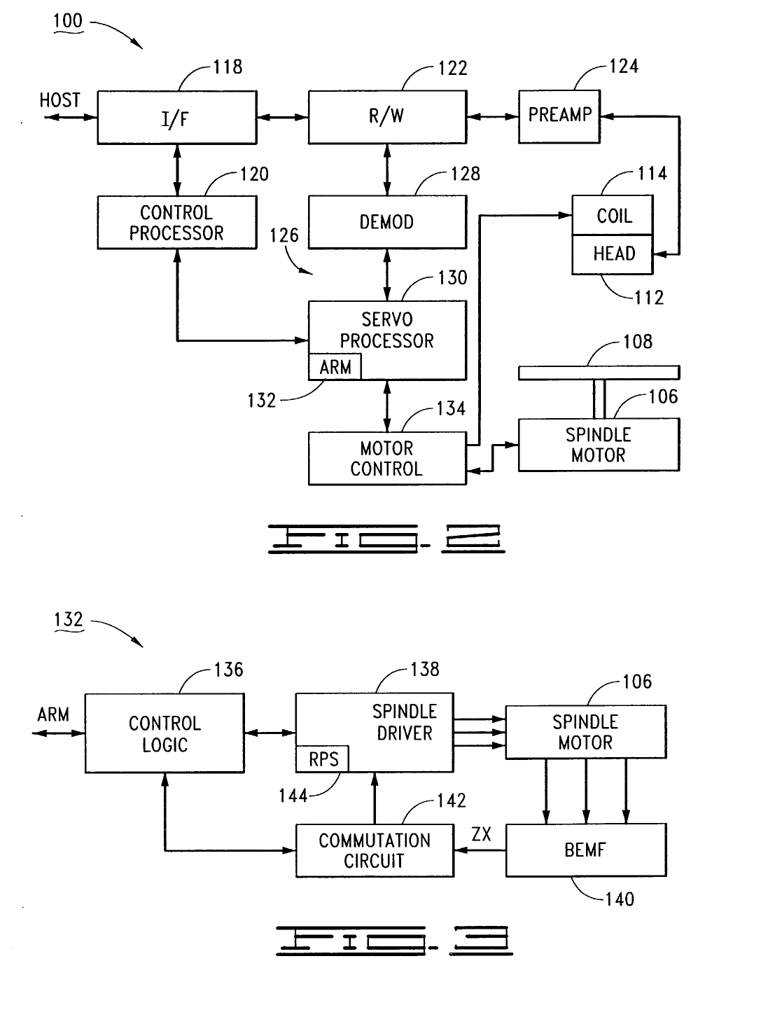

FIG. 2 provides a functional block diagram of the disc drive 100. FIG. 2 includes control circuitry provided on a disc drive printed circuit board (PCB) affixed to the underside of the disc drive 100, and thus not visible in FIG. 1.

Data and host commands are provided from a host device to the disc drive 100 using interface (I/F) circuitry 118 in con junction with a top level control processor 120. Data are transferred between the discs 108 and the host device using the I/F circuitry 118, a read/write (R/W) channel 122, and a preamplifier/driver (preamp) circuit 124.

Head positional control is provided by a closed-loop servo circuit 126 comprising demodulation (demod) circuitry 128, a servo processor 130 (preferably comprising an Advanced RISC Machine, or ARM 132) and motor control circuitry 134. The motor control circuitry 134 applies drive currents to the actuator coil 114 to rotate the actuator 110. The motor control circuitry 134 further applies drive signals to the spindle motor 106 to rotate the discs 108.

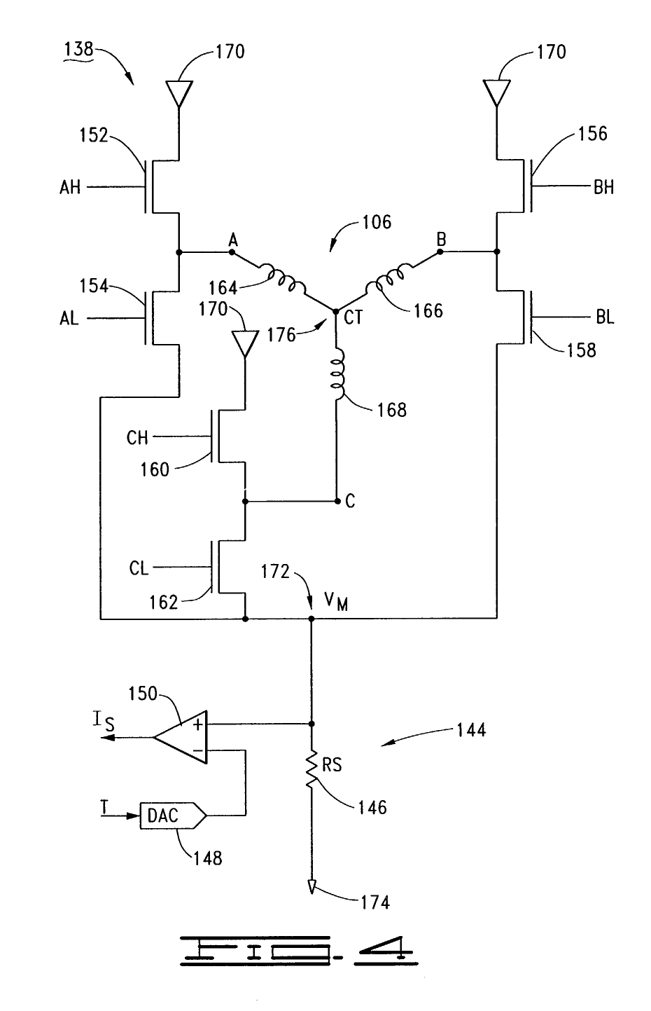

FIG. 3 provides a functional block diagram of relevant portions of the motor control circuitry 134 of FIG. 2. Control logic 136 receives commands from and outputs state data to the ARM 132. Spindle driver circuitry 138 applies drive currents to the phases of the spindle motor 106 over a number of sequential commutation steps to rotate the motor. During each commutation step, current is applied to one phase, sunk from another phase, and a third phase is held at a high impedance in an unenergized state.

Back electromagnetic force (bemf) detection circuitry 140 measures the bemf generated on the unenergized phase, compares this voltage to the voltage at a center tap, and outputs a zero crossing (ZX) signal when the bemf voltage changes polarity with respect to the voltage at the center tap. A commutation circuit 142 uses the ZX signals to time the application of the next commutation step.

The spindle driver circuitry 138 includes rotor position sense (RPS) circuitry 144 to detect electrical position of the spindle motor 106 in a manner to be discussed shortly. At this point it will be noted, with reference to FIG. 4, that the RPS circuitry 144 includes a sense resistor RS 146, a digital to analog converter (DAC) 148 and a comparator 150. FIG. 4 also shows the spindle driver circuitry 136 to include six field effect transistors (FETs) 152, 154, 156, 158, 160 and 162, with inputs denoted as AH (A high), AL (A low), BH, BL, CH and CL, respectively. Controlled, timed application of drive currents to the various FETs result in flow of current through A, B and C phase windings 164, 166 and 168 from a voltage source 170 to V_{M} node 172, through the RS sense resistor 146 to reference node (ground) 174. Spindle motor commutation steps (states) are defined in Table 1:

TABLE 1

| Commutation | Source | Sink | Phase Held at |
|---|---|---|---|
| State | Phase | Phase | High Impedance |
| 1 | A | B | C |
| 2 | A | C | B |
| 3 | B | C | A |
| 4 | B | A | C |
| 5 | C | A | B |
| 6 | C | B | A |

During commutation step 1, phase A (winding 164) is supplied with current, phase B (winding 166) outputs (sinks) current, and phase C (winding 168) is held at high impedance. This is accomplished by selectively turning on AH FET 152 and BL FET 158, and turning off AL FET 154, BH FET 156, CH FET 160 and CL FET 162. In this way, current flows from source 170, through AH FET 152, through A phase winding 164, through the center tap (CT node 176), through B phase winding 166, through BL FET 158 to V_{M} node 172, and through RS sense resistor 146 to ground 174. The resulting current flow through the A and B phase windings 164, 166 induce electromagnetic fields which interact with a corresponding array of permanent magnets (not shown) mounted to the rotor (spindle motor hub), thus inducing a torque upon the spindle motor hub in the desired rotational direction. The appropriate FETs are sequentially selected to achieve the remaining commutation states shown in Table 1.

It will be noted that each cycle through the six commutation states of Table 1 comprises one electrical revolution of the motor. The number of electrical revolutions in a physical, mechanical revolution of the spindle motor is determined by the number of poles. With 3 phases, a 12 pole motor will have four electrical revolutions for each mechanical revolution of the spindle motor.

The frequency at which the spindle motor 106 is commutated, referred to as the commutation frequency FCOM, is determined as follows:

FCOM=(phases)(poles)(RPM)/60 (1)

A three-phase, 12 pole spindle motor operated at 15,000 revolutions per minute would produce a commutation frequency of:

FCOM=(3)(12)(15,000)/60=9,000 (2)

or 9 kHz. The commutation circuit 142 will thus commutate the spindle driver 138 at nominally this frequency to maintain the spindle motor 106 at the desired operational velocity up to and in excess of 15,000 rpm. The foregoing relations can be used to determine the actual motor speed (and therefore speed error) in relation to the frequency at which the zero crossing ZX pulses arc provided from the bemf detection circuitry 140.

During operation, the motor control circuit 134 receives input command velocity values and provides a corresponding output range of velocities of the spindle motor from a lower threshold velocity to an upper operational velocity. The threshold velocity is defined as a relatively low velocity of the motor. The operational velocity is the velocity at which the spindle motor is normally operated during data transfer operations. Velocities above the threshold velocity are high enough to enable the power electronics and speed controllers to regulate the velocity of the motor. Below the threshold velocity the control circuitry is not effective at regulating the velocity of the motor. More specifically, as a result of limitations in the control electronics, the servo code is limited as to the minimum current that can be provided. Commanded velocity values for velocities below the threshold velocity still results in the minimum current value, not a lower current value required for slower motor operation. The control electronics thus limit the current and velocity to minimum values.

These respective velocities can take any number of relative values depending on the particular application, and are generally related to the specific construction of the spindle motor. For purposes of the present discussion, illustrative values are about 2500 revolutions per minute (rpm) for the threshold velocity and about 15,000 rpm for the operational velocity.

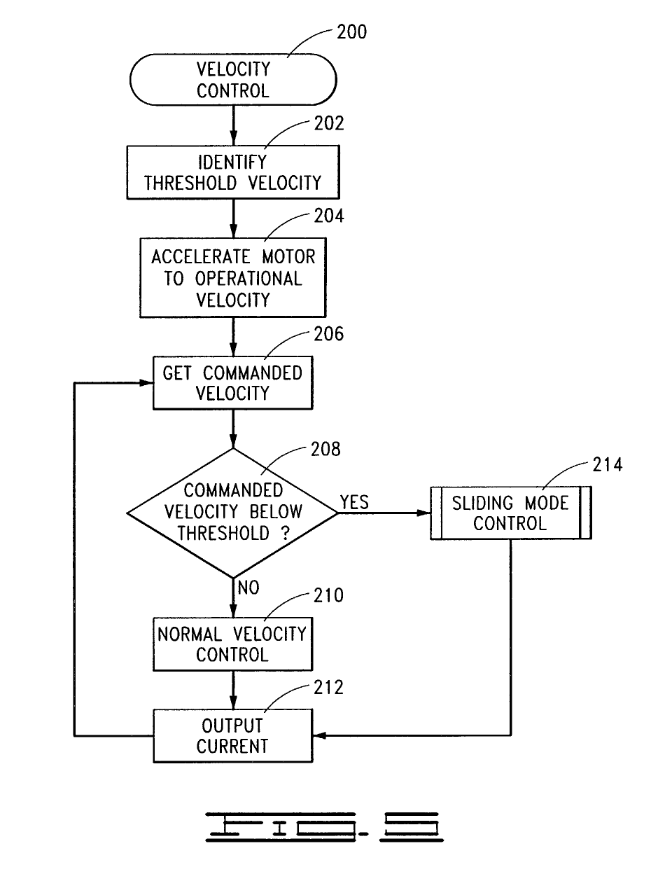

Having concluded a review of relevant circuitry of the disc drive 100, reference is now made to FIG. 5 which provides a flow chart for a VELOCITY CONTROL routine 200 illustrative of steps carried out by the disc drive 100 in accordance with preferred embodiments of the present invention to operate the spindle motor 106 at a desired (commanded) velocity.

The routine initially receives a value for the threshold velocity at step 202. The threshold velocity value is determined prior to operation of the disc drive and varies based on many factors such as motor configuration and control programming. The velocity threshold is the velocity below which a sliding mode control method is desired to control the motor velocity. Typical velocity control methods do not function well below the threshold velocity due to control electronics required for these typical control methods. Elements of the control electronics require minimum values of current that are not obtainable use typical methods. Above the threshold velocity well known methods of motor speed regulation are used, such as proportional-integral (PI), proportional-integral-derivative (PID), or other methods of closed loop control known in the art.

At step 204 the motor is accelerated from rest to its operational speed. Acceleration in this fashion is typically characterized by a period of open loop acceleration until such time as the bemf detection circuitry and the control electronics can provide for closed loop acceleration. Several methods of accelerating a motor from rest to a final operational velocity are well known in the art.

At step 206 the motor control circuitry 134 receives the commanded velocity for the motor 106. The commanded speed can be any value from zero to about the operational velocity. During operational velocity the commanded speed serves to regulate the motor to adjust for variations in the velocity by causing the control circuitry to vary the current. Likewise, during acceleration and deceleration the current is varied in accordance with the desired velocity. For velocities above the threshold velocity elements of the control electronics (such as the DAC 148 and the comparator 150) function properly to allow regulation of the motor velocity.

At decision step 208 the routine determines whether the commanded velocity is below or above the threshold velocity. This determination dictates the type of control that will be implemented by the control circuitry 134. For commanded speeds above the threshold velocity typical control methodologies such as PI or PID are employed, as in step 210.

A resulting drive current is output at step 212 to control the motor at the desired velocity. The routine then returns to step 206 to again receive the commanded velocity as needed for velocity regulation.

In an alternative embodiment the routine responds to the actual velocity of the motor at step 208. In other words, the determination of control methods is based upon actual speed, rather than commanded speed. In this embodiment, the typical control methodology (such as PI or PID) is kept until such point as the motor slows to below the threshold velocity.

If the commanded velocity is found to be below the threshold velocity at step 208, the routine proceeds to subroutine 214 to implement a sliding mode control. In the alternative embodiment discussed above, the subroutine 214 is employed at such point as the actual velocity drops below the threshold velocity. Whether decision step 208 relies on commanded or measured velocity, the routine 200 enters subroutine 214 for values below the threshold value.

At step 216 an estimate or measurement of the actual velocity of the motor is determined. This is easily done by manipulation of equation one above. Solving for RPM, the equation becomes

$$RPM = \frac{60}{( phases ) ( poles ) ( T )} \qquad ( 3 )$$

where T is the period of the bemf signal detected at the bemf circuitry 140. Other methods of estimating or measuring the motor velocity are also readily sufficient.

At step 218 the value of a hyperplane is calculated. In this application of sliding mode control the hyperplane is defined as the motor velocity error, or the difference between the commanded velocity and the measured (or estimated) velocity. Subtracting the measured velocity from the commanded velocity results in a positive or negative value, depending on whether the motor is spinning below or above its commanded velocity.

At decision step 220 the routine determines whether the motor velocity error is positive or negative. A positive error value indicates the motor is turning below the commanded value, while a negative error value indicates the motor is spinning above the commanded value.

If the motor error value is greater than zero at step 220, the routine proceeds to step 222 to set the drive current to a value in the range from the minimum possible current and above. This allows the current input to increase the velocity of the motor. If the motor error value is less than zero at step 220, the routine proceeds to step 224 to set the current to a coast mode. This allows the current input to decrease the velocity of the motor.

In either case, whether the current is set to its zero value or in the range from its minimum and above, the subroutine ends at step 226 and returns to step 212 for the desired value of the drive current to be applied to the motor.

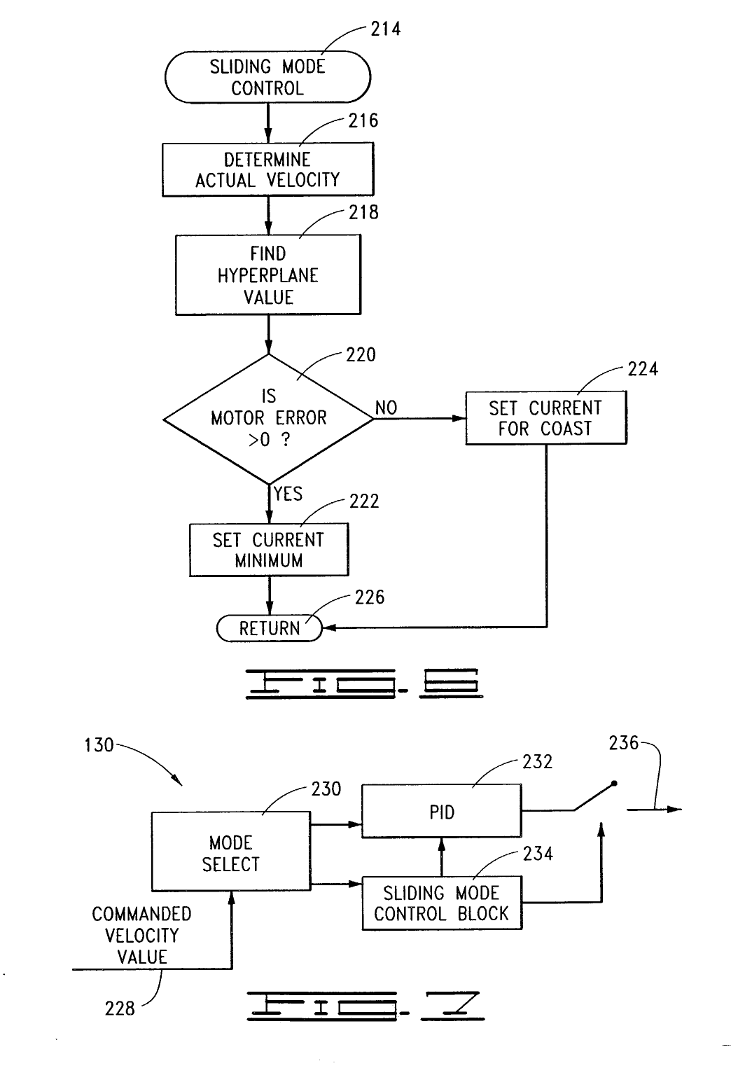

FIG. 7 provides a functional block diagram of the programming suggested by FIGS. 5, 6 and present in the servo processor block 130 (FIG. 2). On data path 228 a commanded velocity value is received from the control processor 120 (as if step 206, FIG. 5). At mode select block 230 a method of control is chosen based on the commanded velocity (as in step 208, FIG. 5). Although this decision is demonstrated as switching control modes based on the commanded velocity, it is also desirable to switch modes based on the measured velocity. This alternative permits control of the motor to be maintained with a PI (or PID) controller until the motor has slowed to the point that the measured motor velocity is at or near the threshold velocity.

The routine then proceeds to block 232 for control to be implemented with a normal PI or PID controller, or to block 234 for control to be implemented with sliding mode control. A current value is then output on data path 236, consistent with the appropriate control method and the commanded velocity.

It will now be appreciated that the routine of FIG. 6 provides several advantages over the prior art. One advantage is that motor velocities not reachable with present methodologies can now be obtained using the programming suggested by FIG. 6. Various applications that require low RPM operation of a motor can now be implemented in situations where low RPM operation is not possible.

Theoretical minimum velocities can be reduced to allow slower operation. This can be useful during engineering and manufacturing testing operations.

Another advantage is the ability to implement the routine into existing code without changes to existing hardware and controller configurations. Relatively minor changes can be made to software or firmware for operation below the threshold velocity. The usefulness of existing electronics is extended so that limitations previously precluding low RPM operation no longer are barriers when using existing electronics.

Yet another advantage is the dependability of sliding mode control and the effect of external factors. Effects of parameter variations, non-linearities and additive noise are negligible, allowing dependable control of the motor velocity.

Accordingly, it will now be understood that the present invention, as embodied herein and as claimed below, is directed to a method and apparatus for decelerating a disc drive spindle motor from an operational velocity to below a threshold velocity. In accordance with preferred embodiments, a disc drive (such as 100) includes a spindle motor (such as 106), back electromagnetic force (bemf) detection circuitry (such as 140) which detects bemf from rotation of the spindle motor, commutation circuitry (such as 142), which electrically commutates the spindle motor in relation to the detected bemf over a range of electrical rotational positions, and control circuitry (such as 120, 134) which controls the velocity of the spindle motor.

During a speed control routine, the spindle motor is initially accelerated from rest to an operational velocity (such as by step 204) and thereafter a commanded velocity is received (such as by step 206). If the commanded speed is above a threshold velocity, typical velocity control methods are employed. If the commanded speed is below a threshold velocity, sliding mode control is employed (such as by subroutine 214). Either control method then outputs a velocity control current (such as by step 212).

The choice of control method can alternatively be determined by the measured speed of the motor, so that a hand off to sliding mode control occurs after the velocity has dropped to the threshold velocity.

A sliding mode control routine determines the velocity of the motor (such as by step 216) and uses this value to determine a hyperplane value (such as by step 218) by finding the difference between the commanded velocity and the measured velocity. If the measured value drops below the commanded velocity a current is applied to drive the motor (such as by step 222) to accelerate the motor. If the measured value is above the commanded value a negligible current or coast mode is applied to drive the motor (such as by step 224) to slow the motor. The commanded velocity is again received to continue regulation of the velocity (such as by step 206).

For purposes of the appended claims, the function of the recited “first means” element will be understood as being carried out by the disclosed structure including the control logic (134, FIG. 3) and the servo processor (130, FIG. 2) programmed in accordance with the routine of FIG. 5.

It is to be understood that even though numerous characteristics and advantages of various embodiments of the present invention have been set forth in the foregoing description, together with details of the structure and function thereof, this detailed description is illustrative only, and changes may be made if detail, especially in matters of structure and arrangement of parts within the principles of the invention to the full extent indicated by the broad general meaning of the terms in which the appended claims are expressed. For example, the particular elements may vary depending on the particular application for the motor start routine while maintaining the same functionality without departing from the spirit and scope of the invention.

In addition, although the embodiments described herein are generally directed to a motor velocity control routine for a disc drive, it will be appreciated by those skilled in the art that the routine can be used for other devices to regulate a rotatable member through a range of velocities without departing from the spirit and scope of the claimed invention.

What is claimed is:

1. A method of operating a motor, comprising:
providing a motor driver circuit that applies current to rotate the motor over an output range of velocities from a lower threshold velocity to an upper operational velocity in response to a corresponding input range of commanded velocity values, wherein the motor driver circuit further rotates the motor at the threshold velocity in response to commanded velocity values corresponding to velocities less than the threshold velocity; and
switching between application of current corresponding to a velocity within the output range of velocities and application of substantially no current to the spindle motor to maintain rotation of the motor at a selected velocity less than the threshold velocity.

2. The method of claim 1, wherein the switching step comprises switching between the application of current corresponding to the threshold velocity and the application of substantially no current to the motor.

3. The method of claim 1, further comprising a step of accelerating the motor from rest to a first velocity within the output range of velocities prior to the switching step.

4. The method of claim 1, wherein the providing step comprises providing the motor driver circuit as a proportional integral controller.

5. The method of claim 1, wherein the switching step is performed by a sliding mode controller.

6. The method of claim 1, wherein the switching step comprises measuring actual velocity of the motor, determining a velocity error in relation to the measured actual velocity and the selected velocity, and switching between the application of the current corresponding to the output velocity range and application of substantially no current in relation to the velocity error.

7. The method of claim 1, wherein the motor adaptively supports a rotatable data storage disc in a data storage device.

8. The method of claim 7, wherein the data storage device further comprises a data head that flies over the rotatable data storage disc, and wherein the method further comprises evaluating fly height characteristics of the head while the motor is maintained at the selected velocity.

9. A data storage device, comprising:
a motor configured to rotate at least one recording disc;
a read/write head configured to write data to the disc and read data from the disc as the motor is rotated at an operational velocity; and
a control circuit that applies current to rotate the motor over an output range of velocities from a lower threshold velocity to the upper operational velocity in response to a corresponding input range of commanded velocity values, wherein the control circuit further rotates the motor at the threshold velocity in response to commanded velocity values corresponding to velocities less than the threshold velocity; and
a sliding mode control circuit that switches between application of current corresponding to a velocity within the output range of velocities and application of substantially no current to the motor to maintain rotation of the motor at a selected velocity less than the threshold velocity.

10. The apparatus of claim 9, wherein the sliding mode control circuit switches between the application of current corresponding to the threshold velocity and the application of substantially no current to the motor.

11. The apparatus of claim 9, wherein the control circuit further accelerates the motor from rest to a first velocity within the output range of velocities prior to the switching by the sliding mode control circuit.

12. The apparatus of claim 9, wherein the control circuit applies current using a proportional integral controller.

13. The apparatus of claim 9, wherein the sliding mode control circuit measures actual velocity of the motor, determines a velocity error in relation to the measured actual velocity and the selected velocity, and switches between the application of the current corresponding to the output velocity range and application of substantially no current in relation to the velocity error.

14. The apparatus of claim 13, wherein the velocity is measured by back electromotive force (bemf) detection circuitry.

15. The apparatus of claim 9, wherein the threshold velocity is determined for each configuration of data storage device.

16. The apparatus of claim 9, further comprising, circuitry for evaluating fly height characteristics of the head while the motor is maintained at the selected velocity.

17. A data storage device, comprising:
a motor configured to rotate at least one recording disc;
a read/write head configured to write data to the disc and read data from the disc as the motor is rotated at an operational velocity;
back electromagnetic force (bemf) detection circuitry coupled to the motor and which detects bemf from rotation of the motor;
commutation circuitry coupled to the bemf detection circuitry and motor which electrically commutates the motor in relation to the detected bemf over a range of electrical rotational positions of the motor; and
first means for controlling the velocity of the motor from a threshold velocity to the operational velocity; and
second means for controlling the velocity of the motor below the threshold velocity.

18. The disc drive of claim 17, wherein the threshold velocity is substantially the minimum velocity by which the first means can control the motor.

19. The disc drive of claim 17, wherein the threshold velocity is limited by control electronics.

20. The disc drive of claim 17, wherein the second means is sliding mode control.
